(19) United States
(12) Patent Application Publication
(10) Pub. No.: US 2002/0187434 A1
(43) Pub. Date: Dec. 12, 2002

(54) Process for device fabrication in which the size of lithographically produced features is subsequently reduced

(76) Inventors: James W. Blatchford JR., Orlando, FL (US); John Frackoviak, New Providence, NJ (US); Roscoe T. Luce, Kissimmee, FL (US); Omkaram Nalamasu, Bridgewater, NJ (US); Allen G. Timko, Flemington, NJ (US)

Correspondence Address: Docket Administrator, Agere Systems Inc., P.O. Box 614, Berkeley Heights, NJ, 07922-0614, US

(21) Appl. No.: 09/924,018

(22) Filed: Aug. 7, 2001

Related U.S. Application Data
(60) Provisional application No. 60/293,576, filed on May 25, 2001.

(51) Int. Cl. G03G 16/00; G21K 5/00; G03C 5/00

(52) U.S. Cl. 430/322; 430/323; 430/324; 378/35; 430/311; 430/312; 430/313; 430/394; 430/296; 430/330

(57) ABSTRACT

A lithographic process is disclosed. In the process, devices are fabricated by a sequence of steps in which materials are deposited on a substrate and patterned. These patterned layers are used to form devices, such as semiconductor devices, optical devices and the like over the substrate. The desired pattern is formed by introducing an image of a first pattern in a layer of energy sensitive material. The image is then developed to form a pattern with features having a first size. Subsequently, the pattern is exposed to an isotropic liquid etchant to reduce the size of the features to a second, smaller size. The pattern having the features of the second, smaller size is then transferred into the underlying substrate or a layer of material formed over the substrate.

### CROSS REFERENCE TO RELATED APPLICATION

This application claims priority of Provisional Application Serial No. 60/293,576 which was filed on May 25, 2001.

### BACKGROUND OF THE INVENTION

1. Technical Field

The present invention is directed to lithographic processes for device fabrication and, in particular, to reducing the size of features lithographically produced in an energy sensitive material prior to transfer of those features into an underlying substrate.

2. Art Background

In lithographic processes for device fabrication, radiation is typically projected onto a patterned mask (also referred to as a reticle) and the radiation transmitted through the mask is further transmitted onto an energy sensitive material formed on a substrate. Transmitting the radiation through a patterned mask patterns the radiation itself and an image of the pattern is introduced into the energy sensitive material when the energy sensitive resist material is exposed to the patterned radiation. The image is then developed in the energy sensitive resist material and transferred into the underlying substrate. An integrated circuit device is fabricated using a series of such exposures to pattern different layers of material formed on a semiconductor substrate.

An integrated circuit device consists of a very large number of individual devices and interconnections therefore. Configuration and dimensions vary among the individual devices. The pattern density, (i.e. the number of pattern features per unit area of the pattern) also varies. The patterns that define integrated circuit devices are therefore extremely complex and non-uniform. Also, as the complexity of such patterns increases the size of individual features in such patterns is decreasing. Specifically, minimum feature size has decreased from 0.5 μm to 0.35 μm to 0.25 μm to 0.18 μm over the past several years. This minimum feature size continues to decrease. As the feature size decreases, the lithographic tools used to create patterns with such features must be adapted and changed.

The ability of lithographic tools to create patterns with the desired feature size is described in terms of pattern resolution. The better the resolution, the closer the correspondence between the mask patterns and the pattern that is created by the tool. A number of techniques have been used to enhance the pattern resolution provided by lithographic tools. The most prevalent technique is the use of shorter wavelength radiation. However, this technique is no longer viable when exposure wavelengths are in the deep ultraviolet (e.g., exposure wavelengths of 248 nm, 193 nm and 157 nm) range. Using wavelengths below 193 nm to improve resolution is presently not economically beneficial because the materials used for lenses in optical lithography cameras absorb this shorter wavelength radiation.

As the size of pattern features continues to decrease, solutions to creating such features that do not require the use of shorter wavelength radiation are sought. One such technique is described in U.S. Pat. No. 5,976.769 to Chapman. FIGS. 1a-c illustrate the method described in Chapman. FIG. 1a illustrates a patterned layer of an energy sensitive material (also referred to herein as a photoresist or, more simply, a resist) formed on a polysilicon layer formed on an SiO₂ layer that is, in turn, formed on a silicon (Si) substrate. In FIG. 1b, the patterned photoresist is isotropically etched by plasma etching. In FIG. 1c the underlying polysilicon layer is anisotropically etched to transfer the pattern defined by the photoresist into the underlying layer of polysilicon. As noted in Chapman, this approach contaminates the polysilicon material. Chapman also notes that the simple and complete removal of the photoresist residue is a problem. This is illustrated in FIG. 1d. Accordingly further improvement in pattern feature size reduction is sought.

### SUMMARY OF THE INVENTION

The present invention is directed to a lithographic process for device fabrication or mask fabrication. Lithographic processes are used to fabricate devices such as integrated circuit devices, optical devices, micro-electromechanical (MEMS) devices, etc. In lithographic processes, a pattern is defined and developed in an energy sensitive material. The pattern is then used as an etch mask to transfer the pattern into a layer of material underlying the energy sensitive material. The underlying layer of material is referred to generically as a substrate. One skilled in the art will appreciate that, in device fabrication, the pattern is typically transferred into a layer of material formed over a bulk substrate.

Referring to FIG. 2, in 10 a pattern with features having a first feature size is produced in an energy sensitive material. In this step, an image of a pattern is introduced into an energy sensitive resist material by projecting patterned radiation onto the energy sensitive material to define an image of a first pattern. The radiation is patterned using conventional techniques such as projecting the radiation through a patterned mask or directly writing the pattern into the energy sensitive material using a beam of radiation. In 20, that first pattern is then developed. The developed pattern features from step 20 have a first size.

After the features are developed, the developed resist is optionally subjected to a post development bake step as indicated in step 30. The baking step is optional and not required. In this step, the developed resist is baked at a temperature that is below the glass transition temperature (T_{g}) of the resist. Typically temperatures in the range of about 100° C. to about 150° C. and duration in the range of 60 seconds to about 90 seconds are contemplated as suitable. In certain embodiments, a post-develop bake will improve the uniformity of the subsequent feature size reduction.

After the pattern is developed (or if the optional baking step is used, after the baking step) the developed resist is subjected to an isotropic liquid etch expedient, as illustrated in step 40. The size of the features subjected to this isotropic liquid etch expedient is further reduced. Examples of suitable isotropic liquid etch developers include weak developers such as tetramethylammonium hydroxide (TMAH). In the context of the present invention, a weak developer is a developer that will isotropically etch the already developed resist in a controllable manner without stripping the resist from the substrate. Aqueous base developers with normality at or below 0.4 N are examples of suitable developers. The selected normality of the liquid etch expedient (within the specified range) and the duration of the etch are selected based upon the specific energy sensitive resist material being used. That is, the etch rate is a function of the normality of the developer and the energy sensitive resist material being etched. The duration of the etch depends upon etch rate and the desired reduction in feature size. Generally a higher developer normality will provide a higher etch rate.

As a result of this step, the feature size is reduced from the feature size in the developed resist. The developed pattern with the reduced feature size is then transferred into the underlying substrate using conventional expedients.

The present invention is further described in terms of specific embodiments. These embodiments are provided to illustrate the present invention. One of ordinary skill in the art will appreciate that various modifications can be made to the disclosed embodiments that are within the scope of the claims below.

### BRIEF DESCRIPTION OF THE DRAWINGS

FIGS. 1a-d illustrate a known sub-lithographic pattern method.

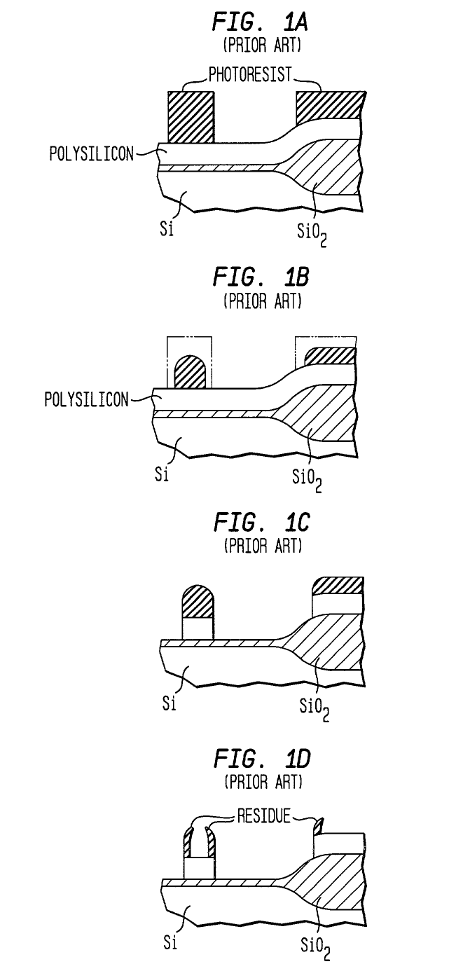

FIG. 2 is a flow chart illustrating the process of the present invention.

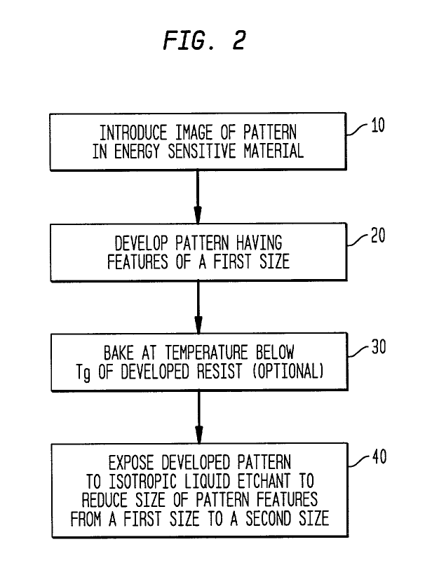

FIGS. 3a and 3b illustrate the process of the present invention.

### DETAILED DESCRIPTION

The present invention is directed to a lithographic process for device fabrication. In the process an image of a pattern is lithographically defined in a layer of energy sensitive material. The image is then developed to form a pattern that is subsequently transferred into an underlying material layer. The underlying material layer is referred to generically herein as a substrate, which includes either a bulk substrate or, more typically, a layer of material formed over a bulk substrate. The present invention contemplates transferring the lithographically defined pattern into an underlying layer to form device features. The present invention also contemplates transferring the lithographically defined pattern into an underlying layer that is used as a “hard mask” for subsequently forming device features in a layer of material underlying the hard mask.

In the process of the present invention, the developed pattern is subjected to further processing before being transferred into the underlying substrate. The patterned resist is subjected to further processing to reduce the size of patterned features in the resist. For example, if the patterned resist has a series of lines and spaces in which the lines are 0.25 μm wide, further processing in the context of the present invention is employed to reduce the line width to 0.18 μm.

Specifically, in the present invention the developed pattern is optionally subjected to a post-develop bake. In this optional baking step, the developed energy sensitive resist material 115 is heated to a temperature that is below the T_{g} of the resist.

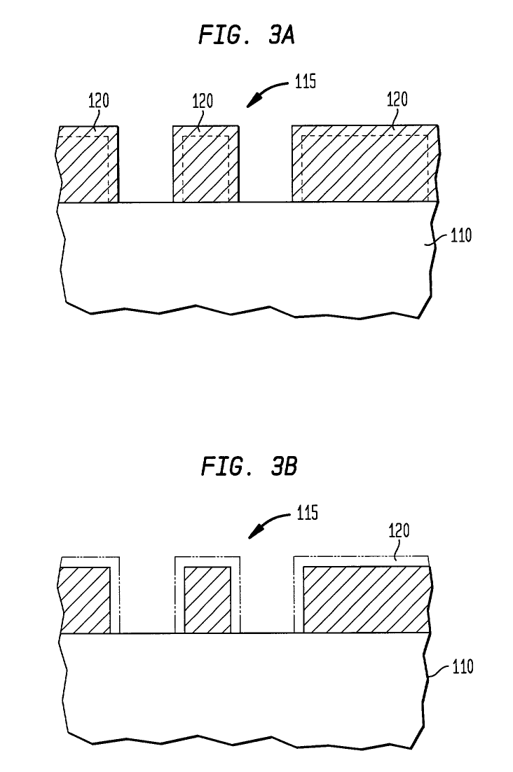

The energy sensitive resist material is subjected to a liquid etchant that dissolves and removes the near surface region affected by the heating step. The liquid etchant is isotropic (i.e. the rate of removal is the same from all directions). FIG. 3A illustrates the near surface region 120 of the resist material 115 formed on a substrate 110. The near surface region 120 will be subsequently removed by the isotropic liquid etchant. Referring to FIG. 3B, the liquid etchant removes the near surface region of the resist 120 (FIG. 3A). The near surface region 120 (now removed) is illustrated by the dashed line in FIG. 3B. In this manner the size of the developed features is reduced without requiring the more complex lithography need to directly produce a pattern with the smaller feature size.

In the present invention, the conditions for the post-development heating step and the subsequent liquid isotropic etch are largely a matter of design choice. That is, the conditions are selected to reduce the feature size by a desired amount. One skilled in the art is able to select the appropriate conditions, based upon the specific energy sensitive resist material that is used. In one embodiment of the present invention, the energy sensitive material is sensitive to deep ultraviolet (DUV) radiation. Such material is sensitive to radiation having a nominal wavelength of 248 nm. The typical feature size that can be resolved in such materials is about 0.18 μm to about 0.25 μm using a conventional binary optical (e.g. chrome-on-glass) mask. Examples of suitable resist materials include chemically amplified resists. Such resists contain a resist polymer that typically has a poly(hydroxystyrene backbone) having acid labile substituents pendant thereto. These acid labile groups render the polymer insoluble in aqueous base solutions that are typically used as developers in lithographic processes. The resist materials also contain a photoacid generator (PAG). The photoacid generator, as its name implies, generates acid when exposed to radiation of an appropriate wavelength.

When the resist is exposed to radiation, the acid generated from the PAG as a result of this exposure causes the acid labile groups to cleave from the polymer. With the acid labile groups cleaved therefrom, the poly(hydroxystyrene) is now soluble in aqueous base developer. When subjected to patterned radiation, the portion of the energy sensitive resist material that is exposed to the radiation becomes soluble in the developer while the portion not exposed to radiation remains insoluble. This affords a basis for contrast between the portion of the resist exposed to radiation and the portion of the resist that is not exposed to radiation. This contrast is exploited to develop a pattern from the image defined by the patterned radiation incident on the energy sensitive material. Energy sensitive resist materials are well known to one skilled in the art and are not described in detail herein.

In this embodiment, at least a portion of the features in the image introduced into the energy sensitive resist material have a nominal dimension of 0.25 μm. The image is then developed into a pattern. Conventional developers, well known to one skilled in the art, are contemplated as suitable.

Following pattern development, the developed pattern is subjected to an isotropic etchant to further reduce the pattern feature size. The isotropic liquid etchant is an aqueous base developer with a normality selected to ensure that the etchant does not strip the resist from the substrate. Solution normalities of 0.4 or less are contemplated as suitable. The normality of the isotropic liquid etchant, and the duration of the etch are selected to obtain the desired feature size reduction. As previously noted, the isotropic liquid etch is optionally preceded by a bake step. Advantageously, the concentration of the developer is chosen such that the etch rate of the energy sensitive material is below about 2 nm/sec.

The present invention is described by way of example using an energy sensitive, chemically amplified resist that is sensitive to DUV radiation. However, the process is not limited to a particular energy sensitive resist material or a particular type or wavelength of exposing radiation. For example, the present process is also contemplated for use in lithographic processes in which the exposure radiation is, for example, X-ray radiation, extreme ultraviolet radiation, 157 nm radiation, 193 nm radiation, I-line radiation or particle beam (e.g. electron beam radiation, ion beam radiation) radiation.

### EXAMPLES

In the following examples, 240 nm lines defined in a DUV energy sensitive resist material using a standard process were reduced in size to 180 nm in a controllable manner. Also in the following examples, features with a nominal dimension of 120 nm (produced by a lithographic process in which a phase shift mask is used) had that nominal dimension reduced to 50-60 nm. In each case, the dimension tolerance (i.e. the acceptable variation in dimensions from feature to feature) was retained.

Both test resolution patterns and test IC device patterns were formed using 248 nm lithography. Two deep-UV resists were evaluated to determine the effects of this process. These resists were evaluated using both organic and inorganic anti-reflective substrates. Resist process parameters such as flood exposure, developer normality, and development times were evaluated to determine their effects on resist thickness loss and critical dimension (CD) reduction.

The experiments were carried out on 200 mm wafers utilizing standard processing equipment. The resist processing was done on two MTI FlexiFab tracks (commercially obtained from Solitec Wafer Processing Inc. of Tewksbury, Mass.) and a TEL ACT8 Clean Track (commercially obtained from Tokyo Electron America of Austin, Tex.). The exposures were done on an Ultra Tech GCA XLS 7800, 248 nm KrF stepper (commercially obtained from the Ultra Tech Corp.). Pattern transfer was done using an Applied Materials AMI 5200 etcher with an EMXP chamber (commercially obtained from Applied Materials of Santa Clara, Calif.). The etch gas mixture used was C₂F₆+O₂. Top-down CD measurements were made using a KLA 8100 SEM (obtained from KLATencor of Kalispell, Montana) and a JEOL 6400F SEM (obtained from JEOL) was used for cross-section micrographs.

Anti-reflection Coatings and Resists:

Anti-reflection coatings were applied over the silicon wafers. The anti-reflection coating was an inorganic dielectric coating containing silicon, oxygen and nitrogen. The coating was deposited on the silicon wafer using chemical vapor deposition. The anti-reflection coating was deposited as three separate layers and had an aggregate thickness of 87.5 nm. Such coatings are described in Cirelli, R., “A Multilayer Inorganic Antireflective System For Use In 248 nm Deep Ultraviolet Lithography,” J. Vac. Sci. Technology B, Vol. 14 p. 4229 (1996), the teachings of which are incorporated by reference herein.

Two deep-UV resists were evaluated. One was Shipley UV-113 and the other was Shipley UV-6. Both resists are deep-UV chemically amplified (poly-hydroxystyrene) types with photosensitivity in the range of 20-50 mj/cm. The resist film thickness was 0.40 μm. The resist film was applied on the anti-reflection coated wafer using the MTI FlexiFab wafer track. Prior to exposing the radiation, the coated wafers were baked at a temperature of 130° C. for sixty seconds.

Exposures and Test Patterns:

The energy sensitive resist materials were exposed to patterned radiation using both binary and phase-shifted reticles containing linewidth control features (LCF), scanning electron microscope (SEM) patterns for cross section micrographs, and integrated circuit gates. Exposure and focus conditions were varied to investigate the effect of exposure conditions on the features that were obtained. Best focus was found to be −0.3 μm for the stepper used for these examples.

Four masks were used to evaluate the process. The masks were configured to be used in the UltraTech GCA 248 nm KrF Stepper lithography tool with a 0.53 numerical aperture. The lithography tool is configured to provide 4:1 image reduction from mask feature size to pattern feature size. The masks contained isolated Field Effect Transistor (FET) gate features configured to provide image features ranging from 100 nm to 300 nm, binary line control image features (240 nm), phase shifted line control image features (180 nm), and SEM cross section image test features ranging from 100-360 nm. The masks were configured to create an image using two exposures, a Poly A exposure and a Poly B exposure. Poly A pattern was exposed first and then the Poly B pattern was exposed. The Poly A binary reticle masked an area, which was later used for the Poly B, phase shifted exposure. The post exposure bake (PEB) and image develop was done only after both exposures were completed.

A partial coherence setting of 0.72 was used to define the pattern of Poly A (binary mask exposure). A partial coherence setting of 0.315 was used to define the pattern of Poly B (the phase-shifted mask exposure). The exposure dose was 24 mJ/cm² for the Poly A exposure and 34 mJ/cm² for the Poly B exposure.

Post Exposure Bake and Image Development:

After exposure, the resist-coated wafers were subjected to a post exposure bake at 130° C. for 90 seconds. The images were developed using a standard development process. The patterns were developed by subjecting the exposed resist to a TMAH 0.262 N developer having a surfactant. The resist was exposed to a stream of developer solution for 15 seconds, followed by a puddle of developer for 45 seconds. After development, the developed pattern was followed by a 15 second rinse using deionized water and a 15 second spin dry.

Linewidth Reduction After Image Development:

Exposing the developed features to an isotropic liquid etchant then further reduced the size of the developed features. Two isotropic liquid etchants were evaluated. Both were aqueous base developer solutions with normality less than 0.4 N. One developer was AZ 327 (commercially obtained from Clariant Corp. in Somerset, N.J.) and the second was TMAH. The effect of normality on the time needed to obtain the desired feature size reduction was investigated for both developers. Developers with normalities in the range of 0.18N to 0.35N were investigated.

Some developed patterns were baked prior to further feature size reduction. The developed patterns, if baked, were baked at 115° C. for 70 seconds. The step of further feature size reduction was conducted in a static mode or in a dynamic mode. In the static mode, the wafer was rotated at 400 rpm for 5 seconds to form a puddle. Once the puddle was formed, the wafer was stationary during the isotropic liquid etch. In the dynamic mode, the wafer was rotated at 400 rpm during the entire isotropic liquid etch.

Experiments and Results:

A controllable rate of resist etch for the process was determined to be in the range of about 1 to about 1.5 nm/s for both of the resists investigated. The effect of development mode on the etch rate was investigated. Generally, higher etch rates were observed for higher developer normalities. Also, for the UV-6 resist and the 0.22 N TMAH developer, the etch rate was observed to be 1 nm/sec in the static mode and 1.25 nm/sec in the dynamic mode.

Observations concerning the effect of the process conditions on the feature size reduction, and the uniformity of feature size reduction, are summarized below.

TABLE 1

| | | | | | | Mean Feature | Linewidth |
|---|---|---|---|---|---|---|---|
| | Isotropic | Post | | | Critical | Size After | Reduction |
| | Liquid | Develop- | Isotropic | | Dimension | Development | Achieved |
| Resist | Etch | ment Bake | Liquid | Mask | Feature | (μm) | (μm) with 3σ |
| Type | Time | Conditions | Etchant | Pattern Type | Type | with 3σ variation | variation |
| UV-6 | 45 s | 115° C./70 s | AZ327 | Binary | L/S¹ | 0.248 (0.023) | −0.079 (.008) |
| | | | (0.22 N) | | Iso² | 0.258 (0.023) | −0.080 (.009) |
| ″ | ″ | 115° C./70 s | AZ327 | Phase | L/S¹ | 0.112 (0.013) | −0.056 (.009) |
| | | | (0.22 N) | Shifted | Iso² | 0.127 (0.013) | −0.060 (.009) |
| ″ | ″ | none | AZ327 | Binary | L/S¹ | 0.246 (0.020) | −0.074 (.008) |
| | | | (0.22 N) | | Iso² | 0.255 (0.026) | −0.077 (.010) |
| ″ | ″ | none | AZ327 | Phase | L/S¹ | 0.112 (0.022) | −0.055 (.008) |
| | | | (0.22 N) | Shifted | Iso² | 0.117 (0.028) | −0.061 (.021) |

¹Lines and Spaces
²Isolated Lines

Table 1 illustrates the size and variation for features (both lines and spaces and isolated lines) after initial pattern development and after further linewidth reduction by exposing the developed features to an isotropic liquid etchant. The features were developed in a UV-6 energy sensitive resist material as previously described. The table reports feature size and feature size reduction for both binary and phase-shifted patterns. The size of the developed features, and the variations in size are reported for both line-and-space and isolated line features. The variation in developed feature size is also reported.

The Table reports that approximately the same amount of linewidth reduction was obtained for both types of features. Also, the amount of feature size reduction that was obtained for the features that were baked prior to further feature size reduction was the same as the feature size reduction for features that were not baked after development. However, for the features formed using the phase shift mask, the variation in feature size reduction was less for the features that were post-developed bake than for the features that were not post-developed baked.

The effect of a time delay on the process was also examined (i.e., the delay between the pattern development and the isotropic liquid etch). A delay of up to five days did not effect the isotropic liquid etch rate. This observation on the effect of time delay was made using a dynamic wet etch with a resist removal rate of 1.1 nm/sec.

The resist features subjected to the post development process were then plasma etched to assess their suitability as hardmask features. Dimensional differences of less than 5 nm and 3σ variations of 3 to 6 nm were observed in the features transferred from the patterned resist into the underlying hard mask (anti-reflection) layer. This indicates that the resist having features reduced in size from post-development processing were suitable for hardmask patterning.

In one example, the initial feature size in the resist was 0.106 μm. After the post-development process (this included a post-develop bake step at 115° C./15 seconds followed by a 45 second isotropic liquid etch) the gate size was reduced to 0.048 μm. The pattern transfer into the hardmask was successful. Only a small etch delta of 6 m was observed. The final feature size after hardmask etch was 54 nm.

What is claimed is:

1. A lithographic process for fabricating an article comprising:
introducing an image of a pattern into a layer of energy sensitive material formed over a substrate;
developing the image to form the first pattern having features of a first size in the energy sensitive material;
reducing the size of at least a portion of the developed features having the first size by exposing the features having the first size to a liquid isotropic etchant to form features having a second size; and
transferring the pattern with the features having a second size into the underlying substrate.

2. The process of claim 1 wherein the image is introduced into the energy sensitive resist material by directing radiation onto a lithographic pattern mask thereby projecting an image of the mask pattern into the energy sensitive resist material.

3. The process of claim 1 wherein the image is introduced into the energy sensitive resist material by directly writing the pattern using a beam of radiation.

4. The process of claim 1 wherein the energy sensitive material is formed on an anti-reflection coating layer formed over a substrate.

5. The process of claim 4 wherein the anti-reflection coating is an inorganic anti-reflection coating.

6. The process of claim 5 wherein the anti-reflection coating is an inorganic dielectric material comprising silicon, oxygen and nitrogen.

7. The process of claim 5 wherein the anti-reflection coating is formed over the substrate by chemical vapor deposition.

8. The process of claim 1 wherein the layer of energy sensitive resist material is formed on a layer of polycrystalline silicon formed over the substrate.

9. The process of claim 2 wherein the wavelength of the radiation directed onto the mask is selected from x-ray radiation, extreme ultraviolet radiation, 157 nm radiation, 193 nm radiation, deep ultraviolet radiation, I-line radiation and particle beam radiation.

10. The process of claim 9 wherein the particle beam radiation is selected from the group consisting of ion beam radiation and electron beam radiation.

11. The process of claim 1 wherein the article is a semiconductor device.

12. The process of claim 1 wherein the article is an optical device.

13. The process of claim 1 wherein the article is a lithographic mask.

14. The process of claim 1 wherein the substrate is a semiconductor substrate on which is formed a layer of oxidized silicon.

15. The process of claim 1 wherein the energy sensitive resist material is a positive energy sensitive resist material.

16. The process of claim 1 further comprising baking the developed pattern before the reducing step.

17. The process of claim 16 wherein the developed pattern is baked at a temperature that is below the glass transition temperature of the energy sensitive material.

18. The process of claim 5 wherein the anti-reflection coating is a hardmask coating.

19. The process of claim 1 wherein the energy sensitive material is formed on a hard mask coating formed over a substrate.
